(19) United States
(12) Patent Application Publication
(10) Pub. No.: US 2021/0054983 A1
(43) Pub. Date: Feb. 25, 2021

(54) MOTOR VEHICLE LIGHTING MODULE

(71) Applicant: HUF HULSBECK & FURST GMBH & CO. KG, Velbert (DE)

(72) Inventor: Gerd BUSCHMANN, Velbert (DE)

(73) Assignee: HUF HULSBECK & FURST GMBH & CO. KG, Velbert (DE)

(21) Appl. No.: 17/051,828

(22) PCT Filed: Mar. 25, 2019
(86) PCT No.: PCT/EP2019/000092

§ 371 Date: Oct. 30, 2020

(30) Foreign Application Priority Data
May 3, 2018 (DE) 102018003553.1

(51) Int. Cl. F21S 43/239; F21S 43/245; B60R 13/00; F21S 43/19; F21S 43/14; F21S 43/249; B60Q 1/00

(52) U.S. Cl. CPC F21S 43/239; F21S 43/245; B60R 13/005; F21Y 2115/10; F21S 43/14; F21S 43/249; B60Q 1/0023; F21S 43/195

(57) ABSTRACT

A motor vehicle lighting module, at least including a housing which is formed by a support plate and a circular or elliptical upper part fastened thereto. The upper part is at least partially light-transmitting and closes off the housing to the outside. A plurality of light sources emitting light beams are accommodated in the housing A disc-shaped light guide is arranged in the housing and the light sources are arranged such that a circular or elliptical ring is formed in which the light guide at least partially lies. The light guide has on its periphery at least one shoulder and projects in the radial direction over the ring formed by the light sources.

The invention relates to a motor vehicle lighting module according to the preamble of claim 1.

Motor vehicle lighting modules of this type, with a housing which is formed by a support plate and a circular or elliptical upper part fastened thereto, wherein the upper part is at least partially light-transmitting and closes off the housing to the outside, and wherein a plurality of light sources emitting light beams are accommodated in the housing, are known from the prior art.

Typically, a support plate of a lighting module has a plurality of light-emitting diodes or parallel light-emitting diode strips which are arranged in rows in an array. The light from the light-emitting diodes is reflected upwards by a reflection plate and uniformly distributed by a light guide plate, so that a homogeneous output light is obtained.

What is disadvantageous with the known motor vehicle lighting modules is however that a large number of light-emitting diodes is required for such backlighting, which increases the thickness, the weight and the power consumption of the lighting module. The known arrangements are unsuitable for illuminating for example an emblem of the motor vehicle manufacturer.

The object of the invention is to provide a motor vehicle lighting module with which illumination, for example of a motor vehicle emblem, is achieved with a smaller number and more effective arrangement of electronic and optical components. In particular, it is desirable for additional electronics, such as for example sensor systems and/or a camera, to be able to be accommodated in the housing of such a lighting module.

This object is achieved according to the invention by a motor vehicle lighting module according to claim 1. Advantageous developments of the invention are set forth in the dependent claims.

It is particularly advantageous in the case of the motor vehicle lighting module, at least comprising a housing which is formed by a support plate and a circular or elliptical upper part fastened thereto, wherein the upper part is at least partially light-transmitting and closes off the housing to the outside, wherein a plurality of light sources emitting light beams are accommodated in the housing, that a disc-shaped light guide is arranged in the housing and the light sources are arranged such that a circular or elliptical ring is formed in which the light guide at least partially lies, wherein the light guide has on its periphery at least one shoulder and projects in the radial direction over the ring formed by the light sources.

Due to the fact that the disc-shaped light guide has a shoulder on its periphery, the light guide is designed with a first portion which has a first diameter, and a second portion which has a second diameter which is larger than the first diameter. The first portion with the smaller diameter lies in the ring formed by the light sources, and the second portion with the larger diameter projects in the radial direction over the ring formed by the light sources.

It is particularly important that the second portion of the light guide with the larger diameter projects in the radial direction over the ring formed by the light sources, so that the light guide is capable of illuminating the circular upper part over its complete circular extent.

The lighting module may be attached to readily visible points on the front end of a vehicle and/or the rear of a vehicle.

The circular upper part of the lighting module may for example have an emblem of a motor vehicle manufacturer, and the light beams emitted by the light sources may serve to illuminate such an emblem. Further electronic components may additionally be arranged in the ring formed by the light sources. Furthermore, the lighting module according to the invention may serve as a position light of a vehicle.

It is conventional to attach an emblem of the motor vehicle manufacturer to a vehicle at certain points, such as for example the front end of a vehicle and/or the rear of a vehicle. The emblem usually has a decorative element in the form of letters, signs or figures or their contours. The feeling of the premium character of a motor vehicle can be increased by illuminating the emblem. In particular, backlighting may be attractive for the visual representation of an emblem. The lighting module according to the invention is particularly suitable for illuminating an emblem of the motor vehicle manufacturer.

Since motor vehicle lighting modules for an emblem are typically attached to central, readily visible points of the front end of a vehicle and/or the rear of a vehicle, it is particularly advantageous for additional electronics, such as for example sensor systems and/or a camera, to be able to be combined with the illumination of the emblem.

In a preferred embodiment, at least some of the light beams of the light sources are directed in the direction of the center or the focal points of the ring and are introduced into the light guide, so that the light guide is illuminated by the light sources arranged opposite on the ring right into that part which projects in the radial direction over the ring formed by the light sources. In the case of a circular ring, this circle has a center. In the case of an elliptical ring, it has two focal points of the ellipse. Owing to the corresponding orientation of at least some of the light beams of the light sources through the center in the case of a circular ring or through the focal points in the case of an elliptical ring, it is ensured that as a result that region of the light guide which lies opposite the light source is illuminated.

The plurality of light sources is arranged in annular manner around a light guide, so that two light sources in each case are located opposite each other and so that the light beams emitted by the light sources enter laterally into the light guide. The light beams emitted by the light sources are propagated in the light guide from one edge of the first portion of the light guide to an opposite edge of the second portion of the light guide, and emerge on the edge of the second portion of the light guide out of the light guide perpendicularly in the direction of the upper part. Owing to the fact that in each case two light sources are arranged lying opposite each other, full illumination of the circular or elliptical upper part over its complete circular or elliptical extent is realized. Preferably to this end the disc-shaped light guide is arranged inclined in the housing. The inclination of the disc-shaped light guide may be realized for example by a slope arranged on the periphery of the support plate.

In a further preferred embodiment, the ring is divided into two parts, in particular two separate portions of the ring in the installation position of the lighting module are separated into a right-hand and a left-hand part by a perpendicular separating line.

In compliance with legal requirements, this makes possible clear assignment of a right-hand half and a left-hand half of the lighting module. Thus for example the two halves may be assigned to the right-hand or left-hand headlights of the vehicle and be switched along with them. Owing to the beam path of the individual light sources, the left-hand part of the ring is thus assigned to the right-hand side of the lighting modules of the motor vehicle, whereas the right-hand part of the ring is assigned to the left-hand side of the lighting modules of the motor vehicle.

In a further preferred embodiment, each of the light sources is arranged on an individual printed circuit board is or a plurality of light sources are arranged on individual printed circuit board and the individual printed circuit boards are electrically connected together by way of an annular lead frame borne by the support plate.

Regardless of whether one or more light sources are arranged on an individual printed circuit board, the individual printed circuit boards are arranged in annular manner around the light guide, so that two printed circuit boards are located opposite each other in each case.

A lead frame is a flat structure produced by stamping. One application is the creation of a system of electrical conductors in only one manufacturing step, produced from a metal strip. Using a lead frame for electrically connecting together the individual printed circuit boards means that high electrical currents can be distributed without problems in a tight space. A lead frame of this type may make possible direct connection to a cable assembly of a motor vehicle by way of multipole plug connectors. Discrete components such as relays or fuses may be mounted on a lead frame by introducing suitable connectors. The lead frame may accordingly have multipole plug connectors.

In a further preferred embodiment, the lead frame is divided into two parts in order to form two circuits which are separate from each other: in particular, the two separate circuits in the installation position of the lighting module are separated into a right-hand and a left-hand part by a perpendicular separating line.

In compliance with legal requirements, the use of two separate circuits makes possible clear assignment of a right-hand half and a left-hand half of the lighting module. Thus for example the two halves may be assigned to the right-hand or left-hand headlights of the vehicle and be switched along with them.

In a further preferred embodiment, one or more cover(s) protecting against direct emergence of light is/are arranged over the light sources, so that the light beams emitted by the light sources are not emitted out to the surroundings, but enter laterally into the disc-shaped light guide.

The cover(s) is/are designed in particular in annular manner, so that the second portion of the light guide which has the larger diameter and which projects in the radial direction over the ring formed by the light sources is completely covered. This also avoids direct emergence of light from the light guide in the direction of the support plate. The cover or covers may have corresponding cutouts at the coupling-in points of the light sources into the light guide. Due to such covers, in particular undesirable illumination effects and reflections are avoided, since exclusively introduction of light beams in the desired orientation from the light sources into the light guide is made possible.

In a further preferred embodiment, the upper part has an outer surface, which is in particular transparently polished, and a three-dimensionally textured inner surface, which corresponds to an emblem, wherein the inner surface has in particular first, non-light-transmitting, regions, in particular with a dark high-gloss appearance, second, limitedly light-transmitting, regions, and third, light-transmitting, in particular transparently polished, regions.

In this case, the outer surface forms a front face of the upper part, on which the backlit emblem is visible. Owing to the three-dimensionally textured inner surface of the upper part, an attractive visual representation of the emblem is made possible. The dark high-gloss appearance of the first, non-light-transmitting, regions may be produced for example by lacquering, vapor deposition, etc. The second, limitedly light-transmitting, regions offer a homogeneous light pattern and may be produced by graining, satin finishing, vapor deposition, lacquering, etc., so that, viewed from outside, a very high-end impression is produced. The third, light-transmitting, regions ensure unhindered emergence of light.

In a further preferred embodiment, a transparent diffusor plate is arranged between the light guide and the upper part, which diffusor plate scatters the light beams emitted by the light sources, wherein the diffusor plate has textured surfaces, in particular micro pyramids geared to the contours of the emblem. With the aid of the diffusor plate, uniform full illumination of the upper part is achieved.

In a further preferred embodiment, each of the light sources is formed by a light-emitting diode.

In a further preferred embodiment, a sensor, in particular a sensor for adaptive cruise control (in particular what is called an ACC sensor), and/or a camera is/are arranged within the ring formed by the light sources and/or in an installation space starting from the upper part behind the plane spanned by the ring.

Furthermore, a signal means coupled with an approach sensor may also be arranged in the ring formed by the light sources and/or in an installation space starting from the upper part behind the plane spanned by the ring. By the illumination of the emblem, then both an indication of a distance from the approach sensor for activation can be given, and also an indication of imminent opening, for example of a tailgate, in particular by rapid flashing and/or a change in color. Thus light-emitting diode units the control of which makes it possible to emit light in different colors can be used as light sources.

In a further preferred embodiment, the lighting module is designed as a high-voltage component.

As the development and introduction of hybrid and electric motor vehicles and other motor vehicles with high-voltage systems advances, more and more high-voltage components are required. “High-voltage” in the automobile sector designates in particular voltages of 48 V or greater or alternatively voltages of 60 V or greater. The development of HV components for the automobile sector in this case is geared in particular to meeting technical requirements. These requirements are met by the lighting module according to the invention.

An example of embodiment of the invention is illustrated in the figures and will be discussed below.

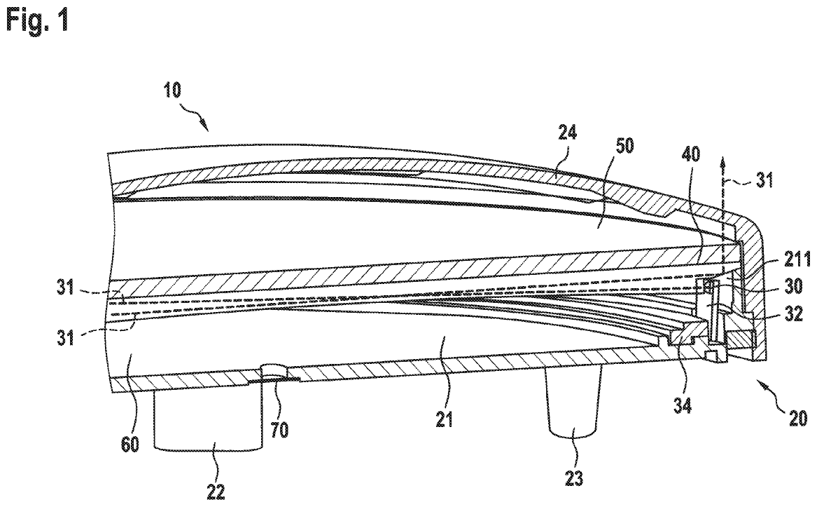

FIG. 1 is a perspective sectional view of a detail of a motor vehicle lighting module;

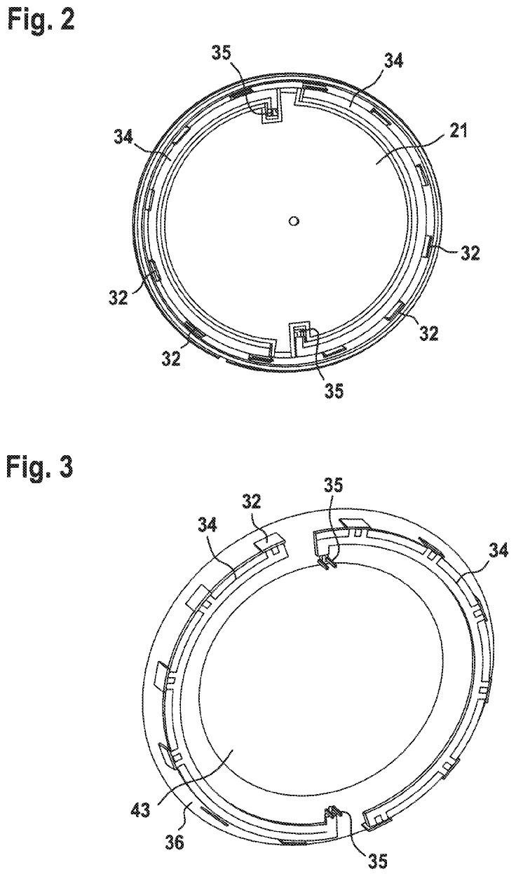

FIG. 2 is a top view of the support plate of the motor vehicle lighting module;

FIG. 3 is a bottom view of the light guide of the motor vehicle lighting module which is connected to the lead frame;

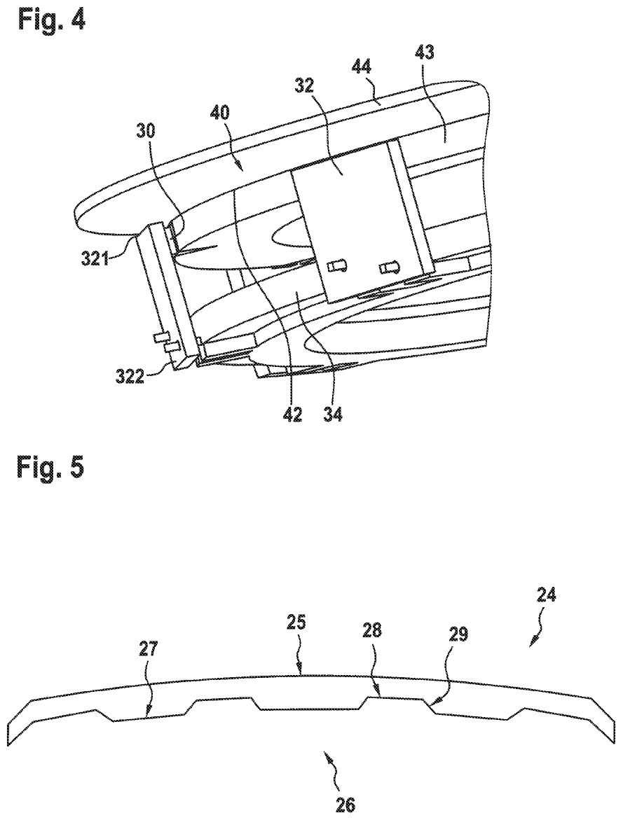

FIG. 4 is a perspective view of a detail of the light guide which is connected to the lead frame;

FIG. 5 is a schematic sectional view of the upper part of the motor vehicle lighting module.

In the figures, identical components are provided with identical reference numerals.

As shown schematically in FIG. 1, a motor vehicle lighting module 10 comprises a housing 20, which is formed by a support plate 21 and a circular upper part 24 fastened thereto. The upper part 24 is partially light-transmitting and closes off the housing 20 to the outside.

The support plate 21 has two multipole plug connectors 22, which each serve for direct connection of a circuit to a cable assembly of a motor vehicle. Furthermore, the support plate 21 has a plurality of fastening devices which serve for fastening the lighting module 10 to a vehicle component, for example to readily visible points of the front end of a vehicle and/or the rear of a vehicle. A slope 211 arranged on the periphery of the support plate 21 may be used to produce an inclination of the disc-shaped light guide in relation to the support plate 21. A coated textile membrane 70 is provided on the outer side of the support plate 21 in order to seal against ingress of moisture into the housing 20.

A plurality of light sources 30 emitting light beams 31 is accommodated in the housing 20. Each of the light sources 30 is formed by a light-emitting diode (LED). Furthermore, a disc-shaped light guide 40 is arranged in the housing 20. The light sources 30 are arranged such that a ring is formed in which the light guide 40 partially lies. The light guide 40 has a shoulder 42 on its periphery, and projects in the radial direction over the ring formed by the light sources 30.

Due to the fact that the disc-shaped light guide 40 has a shoulder 42 on its periphery, the light guide 40 is designed with a first portion 43 which has a first diameter, and with a second portion 44 which has a second diameter which is larger than the first diameter, as can be recognized in particular in FIG. 4. The first portion 43 with the smaller diameter lies in the ring formed by the light sources 30, and the second portion 44 with the larger diameter projects in the radial direction over the ring formed by the light sources 30. Additionally further electronic components, such as for example a sensor for adaptive cruise control (ACC sensor) and/or a camera 60, may be arranged in the ring formed by the light sources 30.

As shown in FIGS. 1 to 4, at least some of the light beams 31 of the light sources 30 are directed in the direction of the center of the ring, which in this example of embodiment is circular, and are introduced into the light guide 40, so that the light guide 40 is illuminated by the light sources 30 arranged lying opposite one another on the ring right into the second portion 44 which projects in the radial direction over the ring formed by the light sources 30.

The plurality of light sources 30 is arranged in annular manner around the light guide 40, so that two light sources 30 in each case are located opposite each other and so that the light beams 31 emitted by the light sources 30 enter laterally into the light guide. The light beams 31 emitted by the light sources 30 are propagated in the light guide 40 from a coupling-in point of a light beam 31 from the light source 30 on the edge of the first portion 43 to the opposing edge of the second portion 44, and emerge from the light guide 40 at the edge of the second portion 44 perpendicularly in the direction of the upper part 24, as is illustrated in FIG. 1.

As can be seen from FIGS. 1 and 3, each of the light sources 30 is arranged on an individual printed circuit board 32. However, a plurality of light sources 30 may also be arranged on an individual printed circuit board 32. The individual printed circuit boards 32 are in each case electrically connected together by way of an annular lead frame 34 borne by the support plate 21.

As shown in FIGS. 2 and 3, the lead frame 34 is divided into two parts, in order to form two circuits which are separate from each other. The two separate circuits in the installation position of the lighting module 10 are separated clearly into a right-hand and a left-hand part by the lead frame which is divided into two parts. Each lead frame 34 has a connection 35 which makes possible a direct electrical connection to a cable assembly of a motor vehicle by way of the multipole plug connector 22 integrated in the support plate 21.

As shown in FIG. 3, a cover 36 protecting against direct emergence of light is arranged over the light sources 30, so that the light beams 31 emitted by the light sources 30 are not emitted out to the surroundings, but enter exclusively laterally into the disc-shaped light guide 40.

As shown in FIG. 4, a printed circuit board 32 has a first end 321 and a second end 322 which is located opposite the first end 321. At the first end 321 there is arranged a light source 30 and at the second end the printed circuit board 32 is electrically and mechanically connected to the lead frame 34, forming a ring the diameter of which corresponds approximately to that of the first portion 43 of the light guide 40. Further electronic components such as for example sensors may be arranged within the ring.

As can be seen in FIG. 1, a transparent diffusor plate 50 is arranged between the light guide 40 and the upper part 24. The diffusor plate 50 scatters the light beams 31 emitted by the light sources 30. The diffusor plate 50 in this case has textured surfaces, not shown. The textured surfaces are micro pyramids geared to the contours of the emblem.

As shown in FIG. 5, the upper part 24 has an outer surface 25, which is transparently polished, and a three-dimensionally textured inner surface 26, which corresponds to an emblem of a motor vehicle manufacturer. The light beams 31 emitted by the light sources 30 serve to illuminate the emblem. The inner surface 26 has first, non-light-transmitting, regions 27 with a dark high-gloss appearance, second, limitedly light-transmitting, regions 28, and third, light-transmitting, regions 29 which are transparently polished. The outer surface 25 forms a front face of the upper part 24, on which the backlit emblem is visible. Owing to the three-dimensionally textured inner surface 26 of the upper part, an attractive visual representation of the emblem is made possible. The dark high-gloss appearance of the first, non-light-transmitting, regions 27 may be produced for example by lacquering, vapor deposition, etc. The second, limitedly light-transmitting, regions 28 offer a homogeneous light pattern and may be produced by graining, satin finishing, vapor deposition, lacquering, etc., so that, viewed from outside, a high-end impression is produced. The third, light-transmitting, regions 29 ensure unhindered emergence of light.

The lighting module 10 is designed as a high-voltage component for use in hybrid/electric motor vehicles and other motor vehicles with high-voltage systems.

### LIST OF REFERENCE NUMERALS

10 motor vehicle lighting module
20 housing
21 support plate
211 slope
22 plug connector
23 fastening device
24 upper part
25 outer surface
26 inner surface
27 first, non-light-transmitting, regions
28 second, limitedly light-transmitting, regions
29 third, light-transmitting, regions
30 light source
31 light beam
32 printed circuit board
321 first end
322 second end
34 lead frame
35 connection
36 cover
40 light guide
42 shoulder
43 first portion
44 second portion
50 diffusor plate
60 sensor for adaptive cruise control
70 textile membrane

1.-11. (canceled)

12. A motor vehicle lighting module, at least comprising a housing which is formed by a support plate and a circular or elliptical upper part fastened thereto, wherein the upper part is at least partially light-transmitting and closes off the housing to the outside, wherein a plurality of light sources emitting light beams are accommodated in the housing, wherein a disc-shaped light guide is arranged in the housing and the light sources are arranged such that a circular or elliptical ring is formed in which the light guide at least partially lies, wherein the light guide has on its periphery at least one shoulder and projects in the radial direction over the ring formed by the light sources.

13. The lighting module according to claim 12, wherein at least some of the light beams of the light sources are directed in the direction of the center or the focal points of the ring and are introduced into the light guide, so that the light guide is illuminated by the light sources arranged lying opposite on the ring right into that part which projects in the radial direction over the ring formed by the light sources.

14. The lighting module according to claim 12, wherein the ring is divided into two parts, in particular in that two separate portions of the ring in the installation position of the lighting module are separated into a right-hand and a left-hand part by a perpendicular separating line.

15. The lighting module according to claim 12, wherein each of the light sources is arranged on an individual printed circuit board or a plurality of light sources are arranged on individual printed circuit boards and the individual printed circuit boards are electrically connected together by way of an annular lead frame borne by the support plate.

16. The lighting module according to claim 15, wherein the lead frame is divided into two parts in order to form two circuits which are separate from each other, in particular in that the two separate circuits in the installation position of the lighting module are separated into a right-hand and a left-hand part by a perpendicular separating line.

17. The lighting module according to claim 12, wherein one or more cover(s) protecting against direct emergence of light is/are arranged over the light sources, so that the light beams emitted by the light sources are not emitted out to the surroundings, but enter laterally into the disc-shaped light guide.

18. The lighting module according to claim 12, wherein the upper part has an outer surface, which is in particular transparently polished, and a three-dimensionally textured inner surface, which corresponds to an emblem, wherein the inner surface has in particular first, non-light-transmitting, regions, in particular with a dark high-gloss appearance, second, limitedly light-transmitting, regions, and third, light-transmitting, in particular transparently polished, regions.

19. The lighting module according to claim 18, wherein a transparent diffusor plate is arranged between the light guide and the upper part, which diffusor plate scatters the light beams emitted by the light sources, wherein the diffusor plate has textured surfaces, in particular micro pyramids geared to the contours of the emblem.

20. The lighting module according to claim 12, wherein each of the light sources is formed by a light-emitting diode.

21. The lighting module according to claim 12, wherein a sensor, in particular for adaptive cruise control, and/or a camera is/are arranged within the ring formed by the light sources and/or in an installation space starting from the upper part behind the plane spanned by the ring.

22. The lighting module according to claim 12, wherein the lighting module is designed as a high-voltage component.
